(19) United States
(12) Patent Application Publication
(10) Pub. No.: US 2005/0126917 A1
(43) Pub. Date: Jun. 16, 2005

(54) Decorative component, method of manufacturing a decorative component, timepiece, and decorated component

(75) Inventor: Kuniaki Morimoto, Suwa-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjyuku-ku (JP)

(21) Appl. No.: 11/013,195

(22) Filed: Dec. 16, 2004

(30) Foreign Application Priority Data
Dec. 16, 2003 (JP) 2003-417728
Dec. 16, 2003 (JP) 2003-417723
Dec. 16, 2003 (JP) 2003-417725
Nov. 11, 2004 (JP) 2004-328160

(51) Int. Cl. C25D 7/00; H01M 4/02

(52) U.S. Cl. 205/50; 205/72; 368/283

(57) ABSTRACT

A first resist is formed on a substrate 4, and a first electroformed part 2 is formed. A second resist is then formed on a decorative face 21 of the first electroformed part 2, and a second electroformed part 3 is formed. Plating is applied as a surface treatment on a decorative face 31 of the second electroformed part 3, the first resist and second resist are then removed, and an indicator component 1 is manufactured. The second electroformed part 3 is formed directly on the decorative face 21 of the first electroformed part 2, so a multi-stage electroformed part can be formed, a more pronounced three-dimensional look can be produced, and a greater variety of designs can be obtained.

### BACKGROUND OF THE INVENTION

1. Field of the Invention

The present invention generally relates to a decorative component. More specifically, the present invention relates to a decorative component formed by electroforming, to a method for manufacturing the decorative component, to a timepiece provided with the decorative component, and to a second decorated component provided with the decorative component.

2. Background Information

Letters, numbers, patterns, and other decorative components applied to a dial or other component of a timepiece are sometimes manufactured by electroforming, as shown in Japanese Laid-open Patent Application No. 10-25591 (pp. 3-5) for example. Japanese Laid-open Patent Application No. 10-25591 is hereby incorporated by reference. A decorative component manufactured by electroforming has a certain degree of thickness, so it is possible to create a decorative component that produces a feeling of solidity. A decorative component can also be formed from a metal so that a high-grade feel can also be produced.

A further enhanced feeling of solidity or a further increase in the variety of designs is also sought for decorative components in conjunction with the recent increase in the variety of designs in timepieces and other decorated objects. However, decorative components manufactured by a conventional electroforming method may have a planar appearance or a flat color, and their adaptation to a large variety of designs is sometimes impossible.

In view of the above, it will be apparent to those skilled in the art from this disclosure that there exists a need for an improved decorative component, method for manufacturing a decorative component, timepiece, and decorated component. This invention addresses this need in the art as well as other needs, which will become apparent to those skilled in the art from this disclosure.

### SUMMARY OF THE INVENTION

An object of the present invention is to provide a decorative component that can be adapted to a large variety of designs, to provide a method for manufacturing the decorative component, and to provide a timepiece and decorated component that are provided with this decorative component or another decorative component manufactured by the manufacturing method.

The decorative component of the present invention includes an electroformed part formed by electroforming, and a decorative part formed directly on the decorative face of the electroformed part. According to the present invention, the decorative part is formed on the electroformed part. Accordingly, the decorative component is endowed with a twofold structure, and a more three-dimensional or protruding decorative component is formed. In short, a decorative part having a large variety of designs can be obtained by forming the decorative part by electroforming or electrodeposition coating, for example. It thereby becomes possible to form a decorative component with a more pronounced three-dimensional structure or a decorative component with a stronger color, and that flexibly adapts to a large variety of designs.

It is preferred in the present invention that the electroformed part constitute a first electroformed part, and that the decorative part constitute a second electroformed part formed by direct electroforming on the decorative face of the first decorative part. A decorative component separately manufactured by electroforming has traditionally been bonded to a decorative component obtained by electroforming in order to produce a feeling of solidity in the decorative component. However, the work of positioning the decorative components or bonding the components together becomes complicated by this method. Unevenness in the relative positioning of the decorative components also occurs, and consistent quality cannot be obtained. Furthermore, the adhesive between the decorative components is sometimes forced out into the periphery, and a good outward appearance cannot be obtained.

In this invention, the second electroformed part is formed directly on the decorative face of the first electroformed part, so the decorative component as a whole is composed of multiple stages of electroformed parts. Thus, a more pronounced three-dimensional look is obtained. It thereby becomes possible to form the decorative component into various shapes. Further, designs can be diversified by selecting the same or different shapes for the first and second electroformed parts, forming the first and second electroformed parts from different materials, and by other methods.

Besides a decorative component having a two-stage structure in which a second electroformed part is formed on the surface of the first electroformed part, the decorative component described herein also includes one having a multistage structure in which the second electroformed part constitutes a first electroformed part, and another second electroformed part is furthermore formed on the surface thereof.

The term “decorative face” of the first electroformed part refers to a face that can be visually identified from the outside when the first electroformed part is formed. Therefore, the term also includes the face of the portion covered by the second electroformed part when the second electroformed part is formed.

It is preferred in the present invention that the surface area of the decorative face of the second electroformed part be smaller than the surface area of the decorative face of the first electroformed part. In this invention, the surface area of the decorative face of the second electroformed part is formed smaller than the surface area of the decorative face of the first electroformed part, thus, the decorative face of the first electroformed part is exposed at the periphery of the decorative face of the second electroformed part. Consequently, the fact that the decorative component has a multistage structure is easily recognizable from the outside, and a more pronounced three-dimensional appearance is formed.

If the second electroformed part were composed of a specific pattern or the like, it would also become possible to form a decorative component in which the pattern is three-dimensionally formed on the foundation of the first electroformed part, and the decorative component can be more easily provided with a variety of designs.

It is preferred in the present invention that a surface-treated layer on which a surface treatment is performed be formed on the decorative face of at least one of the first and second electroformed parts. In this invention, a surface-treated layer is formed on the decorative face of at least one of the first and second electroformed parts, thus, the surface condition of the first and second electroformed parts can be set with a high degree of freedom, whereby the design of the decorative component can be further diversified. Particularly, when the surface-treated layer is formed on the decorative face of either one of the first and second electroformed parts, the surface condition of the decorative face of the first electroformed part becomes different from that of the decorative face of the second electroformed part, and there is a clear delineation between both decorative faces. Consequently, the difference between the first and second electroformed parts becomes easier to identify, and the three-dimensional look of the decorative component is even further improved. A surface condition is also obtained whereby the decorative faces of the first electroformed part and of the second electroformed part differ from each other, so even further diversification of designs is thereby achieved.

The term “surface treatment” used herein refers to electrodeposition plating, electrodeposition coating, vapor deposition, spray coating, other coat-forming treatments to form a coating on a surface, or the like. Surface treatment can also refer to surface cutting, mirror finishing, and other surface machining treatments to machine a surface, or the like.

It is preferred in the present invention that the first decorative part be made of a surface-treated part applied to a portion of the decorative face of the electroformed part. In this invention, a surface-treated part is formed on a portion of the decorative face of the electroformed part, so the decorative face of the electroformed part is exposed in the portion in which the surface-treated part is not formed, and the decorative component as a whole thus has a plurality of types of materials, surface conditions, colors, and other properties. The design is thereby diversified and it becomes possible to adapt flexibly to various designs by composing the electroformed part and the surface-treated part each from various materials and in various colors.

Besides a decorative component having a two-stage structure in which a surface-treated part is formed on the decorative face of electroformed part, the decorative component described herein also includes one having a multistage, multicolor structure in which surface-treated parts are stacked a plurality of times (in a plurality of types) on the decorative face of the electroformed part.

The term “decorative face” of the electroformed part refers to the face that can be visually identified from the outside when the decorative component is arranged on the decorated object, and the decorative face of the electroformed part also includes the portion of the face that is covered by the surface-treated part.

It is preferred in the present invention that the surface-treated part be formed by plating or electrodeposition coating. In this invention, the surface-treated part is formed by plating or electrodeposition coating. Therefore, it also becomes possible to give the surface-treated part a metallic color, and the decorative component is endowed with a high-grade feel. Coloring becomes possible and even more designs can be obtained, particularly when the surface-treated part is formed by electrodeposition coating.

The method for manufacturing a decorative component of the present invention is a method in which a decorative component includes an electroformed part formed by electroforming and a decorative part formed on a decorative face of the electroformed part. The method for manufacturing a decorative component includes an electroformed part resist formation step to form an electroformed part resist used for the electroformed part on a substrate; an electroforming step to form the electroformed part on the substrate by using the electroformed part resist; a decorative part resist formation step to form further a decorative part resist used for the decorative part on the decorative face of the electroformed part; and a decoration step to form the decorative part on the electroformed part by using the decorative part resist.

In this invention, the electroformed part is formed using an electroformed part resist, and the decorative part is formed directly on the decorative face of the electroformed part in the decoration step, so a decorative component having a three-dimensional look is formed, attaching the decorative part to the electroformed part and other operations become unnecessary, and the manufacturing process is simplified. The decorative part is also firmly secured to the electroformed part.

It is preferred in the present invention that the decoration step be made up of a second electroforming step to form a second electroformed part by electroforming on the decorative face of the electroformed part.

In this invention, the first electroformed part is formed by the first electroforming step, and the second electroformed part is formed directly on the decorative face of the first electroformed part by the second electroforming step. The decorative component as a whole is thereby composed of multiple stages of electroformed parts, and a more pronounced three-dimensional look is obtained. It becomes possible with this method to form the decorative component in various shapes, and designs can be diversified by selecting the same or different shapes for the first and second electroformed parts, forming the first and second electroformed parts from different materials, or performing other methods.

The decorative component thus configured may have a two-stage structure in which the second electroformed part is formed on the decorative face of the first electroformed part. It is possible to repeat a prescribed number of times a resist formation step whereby the second electroformed part is set as the first electroformed part and a resist is formed on the surface thereof in the shape of another second electroformed part after the second electroforming step, and an electroforming step for forming another second electroformed part in the shape of the resist, and to form a decorative component having a multistage structure in which a plurality of second electroformed parts is formed on the first electroformed part.

It is preferred in the present invention that the decoration step include a surface treatment step to form a surface-treated part on a portion of the decorative face of the electroformed part. In this invention, the surface-treated part is directly formed on a portion of the decorative face of the electroformed part, thus, it becomes possible to manufacture a decorative component having a plurality of colors or a plurality of materials by a simple manufacturing method. Various qualities and colors are rendered on the decorative face of the decorative component by manufacturing the electroformed part and surface-treated part from various materials using this manufacturing method. Consequently, the decorative component is endowed with an abundant variety of designs by virtue of the differences in surface condition between the decorative face of the electroformed part and the surface-treated part, so it becomes possible to adapt adequately the decorative component to design diversification.

The term “surface treatment” used herein refers to electrodeposition plating, electrodeposition coating, vapor deposition, spray coating, other coat-forming treatments for forming a coating on a surface, and the like. The surface treatment can also refer to surface cutting, honing, mirror finishing, other surface machining treatments for machining a surface, and the like.

It is preferred in the present invention that the surface treatment step include an electrodeposition step to apply plating or electrodeposition coating on the electroformed part. In this invention, an electrodeposition step is provided to apply plating or electrodeposition coating, so metallic colors can be rendered. When electrodeposition coating is performed in the electrodeposition step, a metallic color can be rendered and coloration is also possible, so the variety of available colors is further increased, and designs are diversified.

It is preferred in the present invention that the electroformed part resist and the decorative part resist be of an ultraviolet-degrading type that is degraded by irradiation with ultraviolet rays, and that there be provided an exposure step to expose at least the periphery of the decorative part to ultraviolet rays after the decoration step, and a development step to remove by image development the portion of the electroformed part resist and/or the decorative part resist exposed in the exposure step.

When a decorative component is conventionally manufactured by electroforming, a resist is formed on the substrate so that the substrate is exposed in the shape of the decorative component, and electroformed material is deposited on the exposed portion of the substrate when electroforming is performed. The product is then impregnated with a resist-removing agent, and the resist on the substrate is dissolved and removed. However, in this type of manufacturing method, a solution that is specialized according to the resist must be used to remove the resist, a number of different types of materials are needed for manufacturing increases, and it is complicated to manage the materials. The resist is also removed by a step that is separate from the step for applying electroforming, so the manufacturing process becomes complex and the operation involved therein becomes complicated, making it impossible to achieve shorter manufacturing times and lower costs.

A method has also been performed whereby the resist is baked (after-baked) after electroforming, the substrate and the resist are joined together, and the electroformed decorative component is peeled from the substrate and from the resist. In this method, however, the resist is incorporated into the decorative component when the resist is thickly formed, and the decorative component cannot be satisfactorily peeled from the resist. Drawbacks therefore occur whereby the resist is left behind in the periphery of the decorative component, the decorative component is deformed by the resistive force of the resist, and other defects occur, and the process yield is adversely affected.

In this invention, after the decoration step, ultraviolet exposure is performed at least on the periphery of the decorative part in the exposure step, and the exposed portion of the electroformed part resist and/or the decorative part resist is removed in the image development step. Consequently, when the decorative component is separated from the substrate, the resist is not present on the periphery of the decorative component, so the decorative component can easily be separated from the substrate, and the resist is not left behind in the periphery of the decorative component.

The exposure and development steps performed in order to define the shape of the decorative component on the resist are usually used to remove the resist, so the apparatus, materials, and the like originally used for exposure and development can be used without modification, and the manufacturing process is thereby simpler to manage. The manufacturing process is also simplified and the operation shortened because the same manufacturing apparatus is used as in the electroformed part resist formation step or the decorative part resist formation step.

Furthermore, the resist in at least the periphery of the decorative component is removed in the exposure step and development step, so the resist is also not left behind on the periphery of the decorative component when the decorative component is removed from the substrate, deformation of the decorative component by the resistance of the resist and other defects do not occur, a decorative component having a good appearance is manufactured, and process yield is enhanced.

It is preferred in the present invention that the exposure step be performed for the entire face of the electroformed part resist and the decorative part resist on the substrate. In this invention, exposure is performed for the entire face of the electroformed part resist and the decorative part resist on the substrate, and the entire exposed portion of the resist is therefore removed in the development step. Consequently, the resist does not remain on the substrate, and it becomes possible to reuse the substrate. The manufacturing costs of the decorative component are thereby reduced.

It is preferred in the present invention that the electroformed part be formed in the electroforming step to protrude over the face of the electroformed part resist. In this invention, the electroformed part is formed to protrude over the face of the electroformed part resist in the electroforming step, so the portion of the electroformed part resist over which the electroformed part protrudes is not exposed to ultraviolet rays in the exposure step. In short, the electroformed part resist on the periphery of the decorative component is removed in the development step and a good appearance is maintained, but the electroformed part resist is left behind in the portion sandwiched between the electroformed part and the substrate. The decorative component is thereby firmly retained on the substrate by the remaining electroformed part resist even after the resist has been removed in the development step. Separation of the decorative component from the substrate during operation and other defects are thus eliminated, and the handling properties of the decorative component are enhanced.

The decorative component is also firmly retained on the substrate by the remaining electroformed part resist even when a plurality of decorative components is formed on the substrate in the actual position in which the decoration is disposed on the decorated object, so the position of the decorative components in relation to each other is unchanged, and the positioning thereof is reliable and accurate.

The sealing sheet of the present invention has the aforementioned decorative component or a decorative component manufactured by the aforementioned method for manufacturing a decorative component, an adhesive layer to affix the decorative component to the substrate surface of the decorated component, a peeling sheet attached to the side of the decorative component having the adhesive layer, and a transfer sheet attached to the opposite face of the decorative component from the side on which the peeling sheet is provided. In this invention, since the aforementioned decorative component or a decorative component manufactured by the aforementioned method for manufacturing a decorative component is formed on the sealing sheet, the decorative component is covered by the peeling sheet and the transfer sheet, and the decorative component is therefore prevented from being damaged. Drying of the adhesive layer is also prevented, thus making it possible to store the decorative component for a long time with the adhesive layer already formed thereon.

The sealing sheet is also not limited to being provided with one decorative component, and a plurality of decorative components may also be provided for a single sealing sheet.

A timepiece of the present invention has the aforementioned decorative component or a decorative component manufactured by the aforementioned method.

A more complex decorated component of the present invention has the aforementioned decorative component or a decorative component manufactured by the aforementioned method.

In this invention, the timepiece or decorated component is provided with the aforementioned decorative component or with a decorative component manufactured by the aforementioned method for manufacturing a decorative component, so the timepiece has good appearance and can easily be adapted to a variety of designs.

### EFFECT OF THE INVENTION

Design diversification can easily be adapted by using the decorative component, the method for manufacturing a decorative component, the timepiece provided with the decorative component, and the decorated component provided with the decorative component according to the present invention.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a diagram depicting a timepiece according to a first preferred embodiment of the present invention;

FIG. 2 is a perspective view depicting a decorative component of the timepiece;

FIG. 3 is a view of a flowchart of a manufacturing method of the decorative component;

FIG. 4 is a view of a diagram depicting an electroforming resist formation step of the manufacturing method;

FIG. 5 is a view of a diagram further depicting the electroforming step of the manufacturing method;

FIG. 6 is a view of a diagram depicting a surface-treated resist formation step of the manufacturing method;

FIG. 7 is a view of a diagram depicting an electrodeposition step of the manufacturing method;

FIG. 8 is a view of a diagram depicting a resist removal step of the manufacturing method;

FIG. 9 is a view of a diagram depicting a transfer step of the manufacturing method;

FIG. 10 is a view of a diagram depicting an adhesive application step of the manufacturing method;

FIG. 11 is a view of a diagram depicting an affixing step of the manufacturing method;

FIG. 12 is a perspective view depicting a decorative component according to a second preferred embodiment of the present invention;

FIG. 13 is a view of a flowchart showing a manufacturing method of the decorative component according the second embodiment;

FIG. 14 is a view of a diagram depicting an electroforming resist formation step of the manufacturing method of the second embodiment;

FIG. 15 is a view of a diagram further depicting the electroforming step of the manufacturing method of the second embodiment;

FIG. 16 is a view of a diagram depicting a surface-treated resist formation step of the manufacturing method of the second embodiment;

FIG. 17 is a view of a diagram depicting an electrodeposition step of the manufacturing method of the second embodiment;

FIG. 18 is a view of a diagram depicting a resist removal step of the manufacturing method of the second embodiment;

FIG. 19 is a view of a diagram depicting a transfer step of the manufacturing method of the second embodiment;

FIG. 20 is a view of a diagram depicting an adhesive application step of the manufacturing method of the second embodiment; and

FIG. 21 is a view of a diagram depicting an affixing step of the manufacturing method of the second embodiment.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Embodiments of the present invention will be described hereinafter based on the drawings. The same symbols are used in the second embodiment to indicate the same components and components having the same function as the components constituting the first embodiment described hereinafter.

### First Embodiment

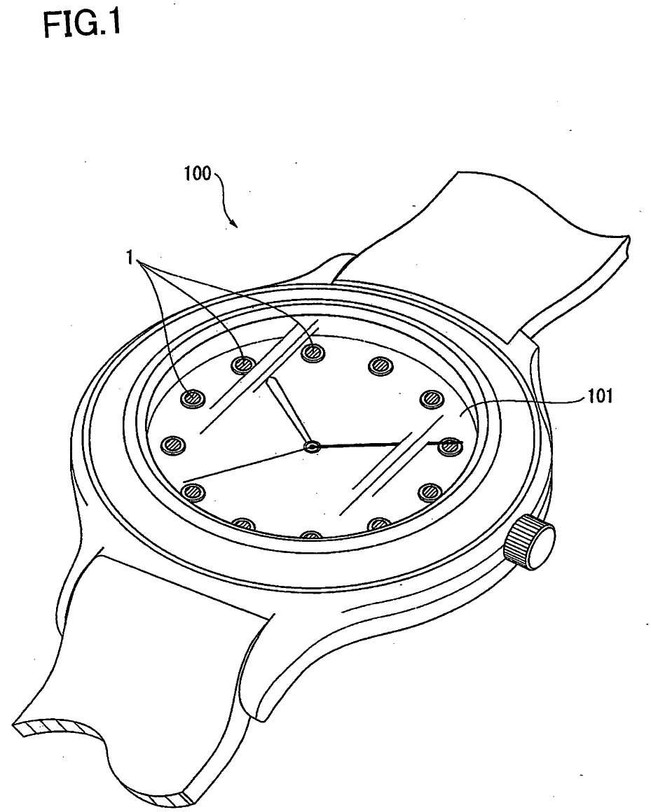

As seen in FIG. 1, a timepiece 100 has indicator components 1 used as decorative components in accordance with a first preferred embodiment of the present invention. In FIG. 1, the indicator components 1 are affixed to a dial (base material) 101 of the timepiece 100 that is the decorated component. The indicator components 1 are used to decorate the timepiece 100, and a plurality thereof is attached to the indicator portion on the dial 101.

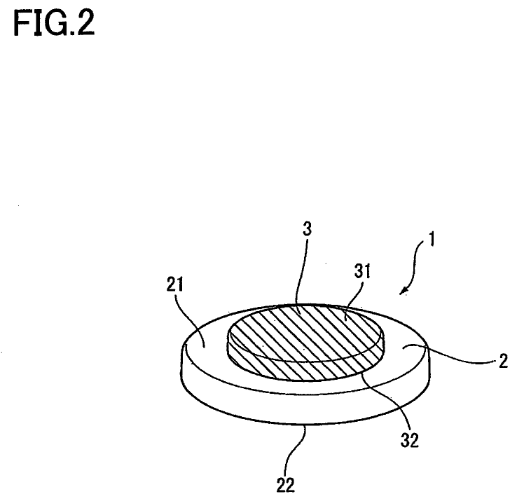

FIG. 2 shows a perspective view of one of the indicator components 1. In FIG. 2, the indicator component 1 is provided with a first electroformed part 2 as the electroformed part affixed to the dial 101 and a second electroformed part 3 as the decorative part formed on the decorative face 21 of the first electroformed part 2.

The first electroformed part 2 is manufactured by electroforming and is provided with an affixed face 22 that is affixed to the dial 101 with an adhesive or the like, and a decorative face 21 that is opposite the affixed face 22 and whose surface can be visually identified from the outside the dial 101. This first electroformed part 2 is composed of nickel (Ni), copper (Cu), gold (Au), silver (Ag), or another suitable metal material, for example, to minimize residual stress after formation thereof.

The second electroformed part 3 is manufactured by electroforming in the same manner as the first electroformed part 2. The second electroformed part 3 is provided with a fixed face 32 and a decorative face 31. The fixed face 32 is fixed to the decorative face 21 of the first electroformed part 2. The decorative face 31 is separate from the fixed face 32 and has a surface whose surface can be visually identified from the outside of the dial 101. The second electroformed part 3 is composed of a suitable metal material in the same manner as the first electroformed part 2, and gold plating or the like is applied to the decorative face 31 by flash plating (approximately 0.1 to 0.5 μm thick).

This type of indicator component 1 is manufactured by the following process.

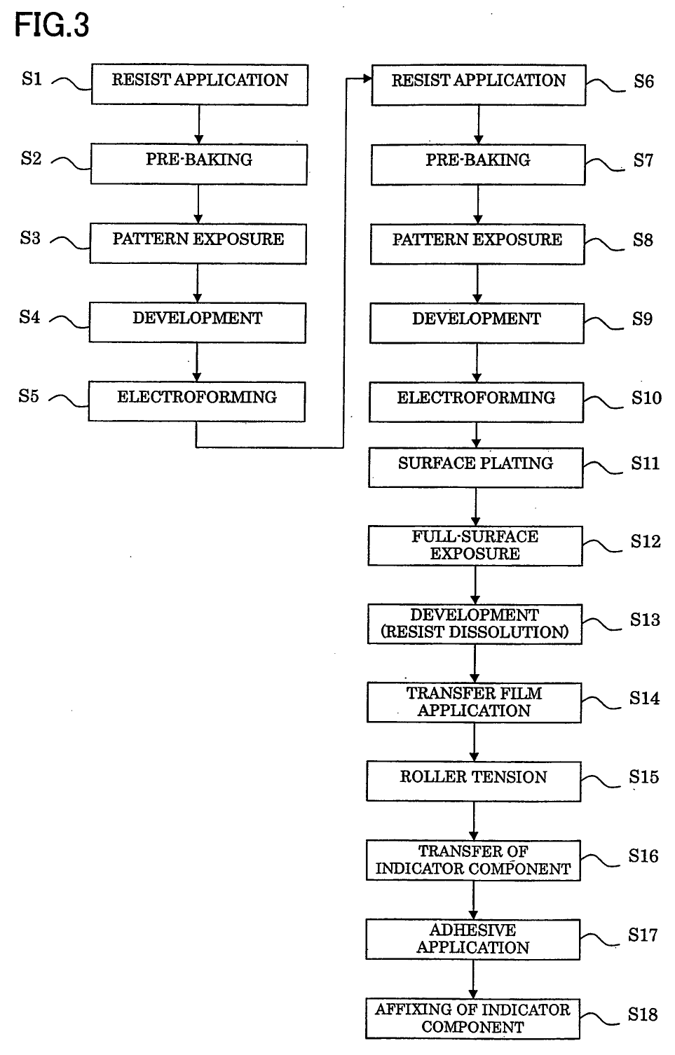

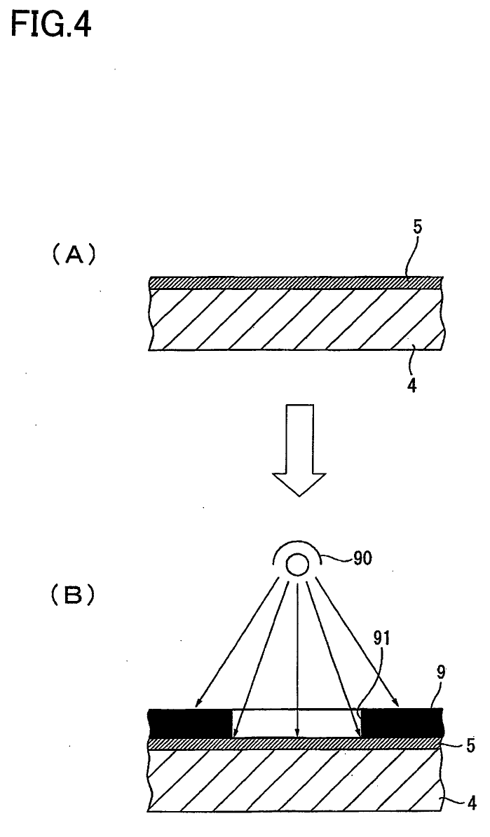

A flowchart of the manufacturing method of the indicator component 1 is shown in FIG. 3. The manufacturing steps leading up to completion of the indicator component 1 are also shown in FIGS. 4 through 11. As shown in FIG. 3, the method for manufacturing the indicator component 1 has a first resist formation step (steps S1 through S4, electroformed part resist formation step) to form a first resist 5 on a substrate 4 as an electroformed part resist used for the first electroformed part 2. The method has a first electroforming step (step S5, electroforming step) to form the first electroformed part 2 using the first resist 5, a second resist formation step (steps S6 through S9, decorative part resist formation step) to form a second resist 52 on the decorative face 21 of the first electroformed part 2 as the decorative part resist used for the second electroformed part 3, a second electroforming step (step S10, decoration step) to form the second electroformed part 3 using the second resist 52, a surface-treatment step (step S11) to apply a surface treatment to the decorative face 31 of the second electroformed part 3, and a resist removal step (steps S12 through S13) to remove the first resist 5 and second resist 52 on the substrate 4. The resist removal step is followed by a transfer step (steps S14 through S16) to transfer the indicator component 1 thus formed from the substrate 4 to a transfer sheet 7, an adhesive application step (step S17) to apply an adhesive to the affixed face 22 of the indicator component 1, and an affixing step (step S18) to affix the indicator component 1 to the dial 101.

As seen in FIG. 3 and line (A) of FIG. 4, in the first resist formation step, the first resist 5 is first formed from a resist agent on the substrate 4 in step S1. The surface finish of the substrate 4 in this step is composed of a uniformly planar member to provide a uniform thickness in electroforming. The material of the substrate 4 preferably has electrical conductivity, and nickel silver (NS), copper (Cu), steel stock, or the like, for example, may be used for this material. Alternatively, the substrate 4 may be obtained by forming a conductive coating on the surface of a nonconductive material.

The resist agent is composed of a nonconductive material, and an exposed and developed material (positive liquid resist; ultraviolet-degraded) is employed. For example, P-RM300PM manufactured by Tokyo Ohka may be employed. This resist agent is used to form the first resist 5 on the surface of the substrate 4 by printing, painting, coating, film pasting, bar coding, roll coating, or other methods. A layer that is acid resistant, alkali resistant, and nonconductive is formed on the surface of the substrate 4 by the first resist 5. The thickness of the first electroformed part 2 and other factors are taken into account in appropriately determining the thickness of the first resist 5. When the first resist 5 forms a film-shaped resist, a prescribed number of layers of film may be layered in order to achieve the desired thickness. In general, a first electroformed part 2 that is three-dimensional and has a good appearance can be obtained if the thickness of the first resist 5 is 30 μm or more.

In step S2, the first resist 5 is pre-baked by heat-treating the first resist 5 for each substrate 4. Pre-baking is performed by heating and drying the assembly at 90° C.±5° C. for 45 minutes. By this pre-baking step, the first resist 5 is stabilized, the adhesion thereof with the substrate 4 is improved. Thus, peeling of the first resist 5 from the substrate 4 is prevented. When the thickness of the first resist 5 is set to 10 μm or above, a first resist 5 of the desired thickness should be formed by repeating the application of the resist agent and performing pre-baking a plurality of times.

Next, in step S3, as shown in line (B) of FIG. 4, the first resist 5 is covered with a mask 9 and is exposed to ultraviolet rays. A transparent pattern 91 having substantially the same shape as that of the affixed face 22 of the first electroformed part 2 is formed on the mask 9, and pattern exposure whereby only the portion corresponding to the pattern 91 is irradiated with ultraviolet rays is performed by exposing the first resist 5 to ultraviolet rays from a light source 90 through the mask 9. By this pattern exposure, the shape of the pattern 91 is transferred to the portion of the first resist 5 irradiated with the ultraviolet rays, and the corresponding portion is degraded. To form the first electroformed part 2 to a thickness of 10 μm, an ultraviolet intensity of 700 mm/j to 1,000 mm/j is needed.

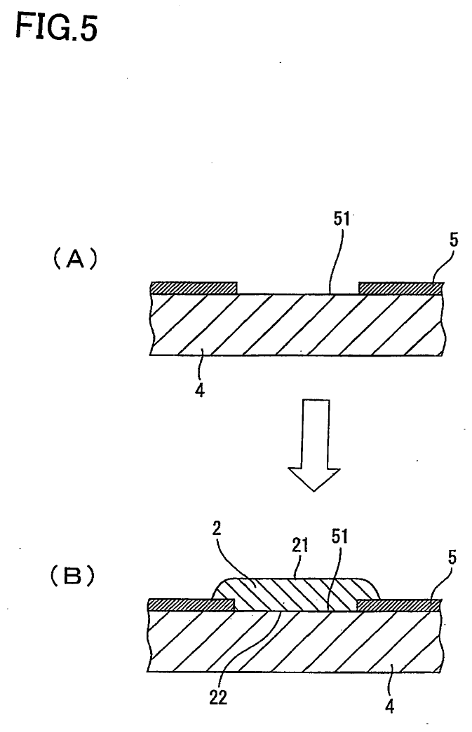

Referring now to line (B) of FIG. 4 and line (B) of FIG. 5, when the first electroformed part 2 is formed on the substrate 4 in this arrangement, the first electroformed part 2 is overlaid to protrude from the first resist 5, so the actual dimensions thereof become larger than the shape of the pattern 91. Consequently, the shape of the pattern 91 is set after first taking into account this dimensional difference.

Referring now to FIG. 3 and line (B) of FIG. 4, in step S4, the exposed substrate 4 and first resist 5 are developed and rinsed by a common alkali development, solvent method, or other method. A 4% aqueous solution of NaOH, for example, is used as the developing solution in this step. The developing solution is preferably used at a controlled temperature of 30° C.±5° C., and a shower system, agitator, or the like may be used for the developer.

As shown in line (A) of FIG. 5, the portion of the first resist 5 corresponding to the pattern 91 on the substrate 4 is then removed, and a first electroforming part 51 is formed in the shape of the pattern 91. The substrate 4 is exposed in the area inside this first electroforming part 51.

As seen in line (B) of FIG. 5, in the first electroforming step, the first electroformed part 2 is formed in step S5 by electroforming. It is necessary at this time that the electroconductivity of the substrate 4 be retained and that the first electroformed part 2 formed by electroforming be made easy to peel from the substrate 4. Passivation treatment to form an insulating covering is therefore performed in advance by subjecting the substrate 4 to degreasing, alkali rinsing, activation by acid neutralization, and immersion in an aqueous solution of sodium sulfide prior to the first electroforming step, and the first electroformed part 2 is then formed on the substrate 4 in an electroforming tank.

Electroforming is performed under common electroforming conditions. For example, the following materials may be used for the electroforming solution: 300±20 g/L of nickel sulfate (powder), 50±5 g/L of nickel chloride (powder), 45±5 g/L of boric acid (powder), 6±1 mL/L of brightener #61 (liquid) to reduce the surface tension of the first electroformed part 2 and reducing the electroforming stress of the first electroformed part 2, an appropriate quantity (an appropriate quantity thereof may be added when cloudiness or the like occurs on the surface of the first electroformed part 2) of brightener #62 (liquid) to impart luster to the surface of the first electroformed part 2, and 18±3 mL/L of brightener #63 (liquid) to increase the surface tension of the first electroformed part 2 and overlaying the material in the mushroom shape of the first electroformed part 2. The electroforming solution is manufactured by dissolving these materials in 250 L purified water. The electroforming solution is preferably kept at a temperature of 55° C.

In this arrangement, electroforming is performed for 11 hours at a current of 3 A when the first electroformed part 2 is formed with a thickness of 180 μm, for example. Consequently, when the first electroformed part 2 is formed with a thickness of 40 82 m, a processing time of 88 minutes at a current of 5 A is required.

In this first electroforming step, the electroforming solution is introduced into the area inside the first electroforming part 51 on the substrate 4, the electroforming solution is forced out over the upper face of the first resist 5 on the external periphery of the first electroforming part 51, and the material is overlaid.

In this first electroforming step, the affixed face 22 is formed from the portion attached to the substrate 4, and the decorative face 21 is formed from the portion overlaid on the face on the opposite side from the substrate 4. The after-baking to enhance the adhesion of the first resist 5 to the substrate 4 is not performed after the first resist 5 is developed and before the first electroforming step is performed.

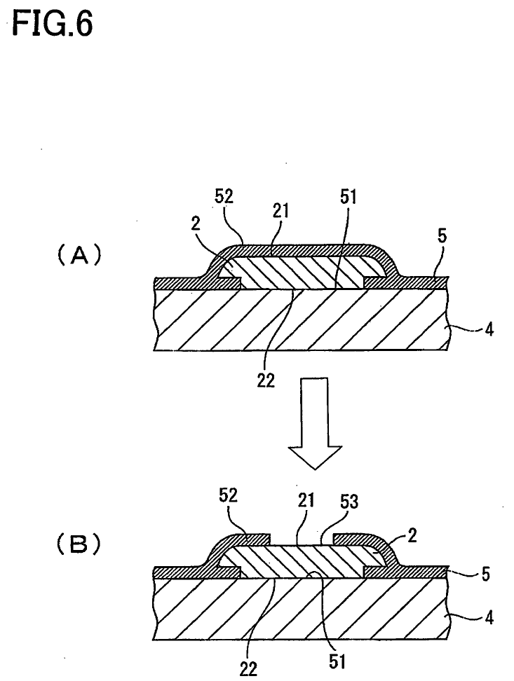

As shown in line (A) of FIG. 6, in the second resist formation step, a second resist 52 is formed on the decorative face 21 by the same method as the first resist 5 in steps S6 and S7. In step S8, the second resist 52 and first resist 5 are then covered with a mask (not shown) in which a pattern is formed having substantially the same shape as the second electroformed part 3, and ultraviolet exposure (pattern exposure) is performed. The substrate 4 is developed in step S9, whereupon the portion of the second resist 52 in the pattern irradiated with ultraviolet rays is removed and a second electroforming part 53 is formed such as depicted in line (B) of FIG. 6. The decorative face 21 of the first electroformed part 2 is exposed in the area inside this second electroforming part 53.

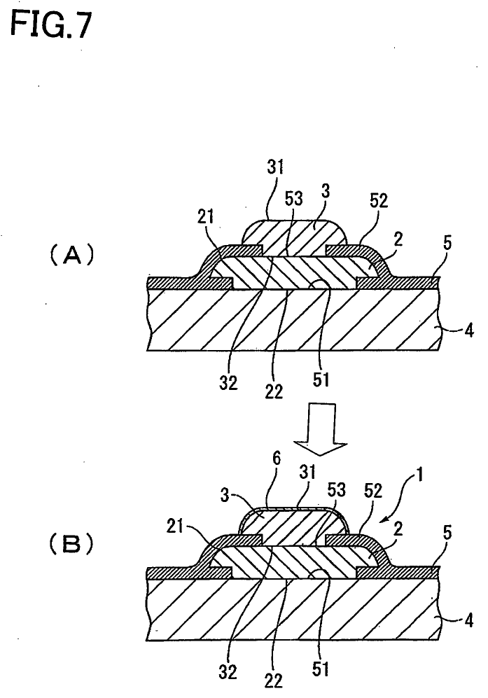

As seen in line (A) of FIG. 7, in the second electroforming step, the second electroformed part 3 is formed by performing electroforming in step S10. The first electroformed part 2 and the second electroformed part 3 must be affixed to each other at this time, thus, only activation treatment is performed, and such passivation treatment as was performed in the first electroforming step becomes unnecessary.

In this second electroforming step, the second electroformed part 3 is formed on the decorative face 21 by substantially the same procedure as in the first electroforming step. The same materials as those in the first electroformed part 2 are preferably used for the second electroformed part 3. The second electroformed part 3 is also overlaid in the same manner as the first electroformed part 2 by introducing the electroforming solution into the area inside the second electroforming part 53 and forcing the solution out from the external periphery of the second electroforming part 53. The fixed face 32 is thereby formed from the portion attached to the first electroformed part 2, and the decorative face 31 is thereby formed from the portion overlaid on the opposite face of the fixed face 32. After-baking is not performed after the second resist 52 is developed and before the second electroforming step is performed.

In the surface treatment step, the decorative face 31 of the second electroformed part 3 is flash-plated with gold in step S11, and a plating layer 6 is formed as a surface treatment layer on the decorative face 31, as depicted in line (B) of FIG. 7.

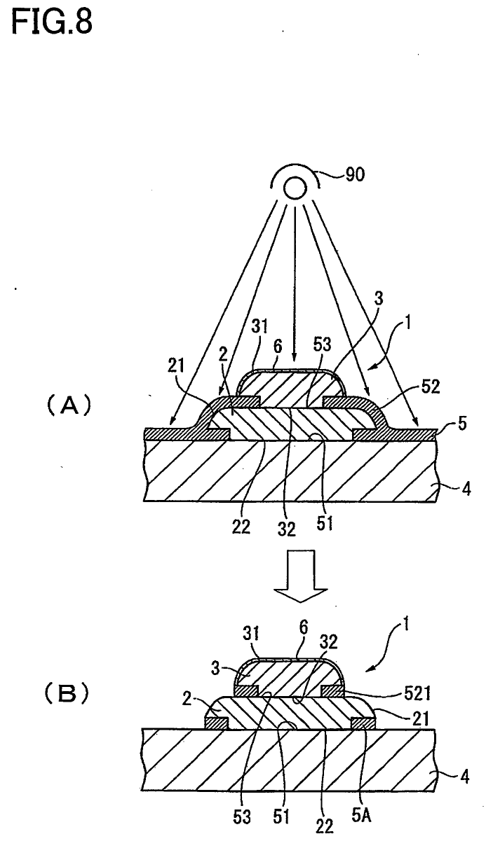

As shown in FIG. 8, the resist removal step has an exposure step to irradiate the first resist 5 and second resist 52 with ultraviolet rays, and a development step to remove by image development the portion of the first resist 5 and second resist 52 exposed in the exposure step. First, the entire face of the first resist 5 and second resist 52 on the substrate 4 is exposed to ultraviolet rays from a light source 90 in step S12, as depicted in line (A) of FIG. 8 (exposure step). The portions of the first resist 5 and second resist 52 that are exposed to the outside are thereby irradiated with ultraviolet rays from the light source 90, and the resist agent in the corresponding portions is degraded.

The substrate 4 is then developed in step S13, whereupon the first resist 5 and second resist 52 thus irradiated are dissolved and removed as depicted in line (B) of FIG. 8, and the decorative face 21 of the first electroformed part 2 and the substrate 4 on the periphery thereof is exposed (development step).

The indicator component 1 is formed on the substrate 4 according to the manufacturing process described above. In this arrangement, the decorative faces 21 and 31 protrude over the faces of the first resist 5 and the second resist 52 while overlaid on the external periphery of the affixed face 22 of the first electroformed part 2 and the external periphery of the fixed face 32 of the second electroformed part 3. Therefore, portions not exposed to ultraviolet rays remain due to the fact that these portions are covered by the decorative faces 21 and 31. These portions of the first resist 5 and the second resist 52 are therefore not degraded, and the remaining portions 5A and 521 of the first resist 5 and the second resist 52 remain in these portions.

At this time, activation treatment and passivation treatment are performed between the affixed face 22 of the first electroformed part 2 and the substrate 4, so these components are easily peeled apart. Since the remaining portion 5A that is not exposed on the external periphery of the affixed face 22 is left behind when the first resist 5 and the second resist 52 are removed, the indicator component 1 is fixed and retained on the substrate 4 by the bond between the remaining portion 5A and the first electroformed part 2.

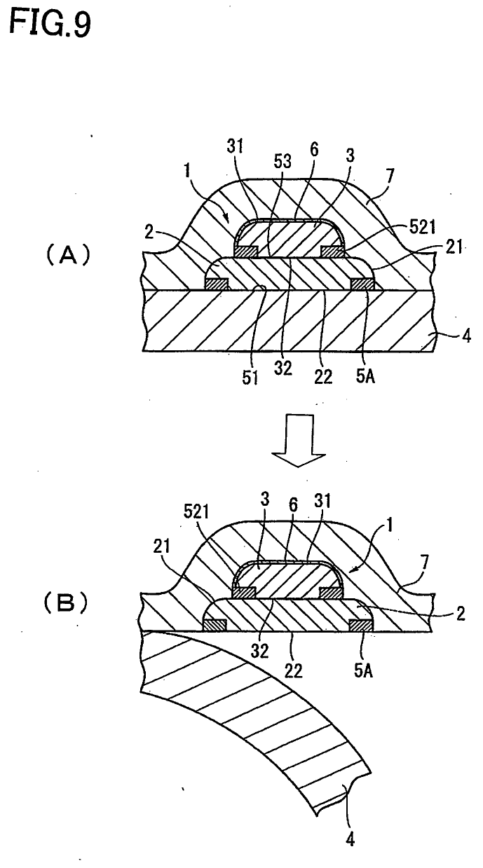

As shown in line (A) of FIG. 9, in the transfer step, a transfer sheet 7 is affixed to the indicator component 1 and the substrate 4 in step S14. An adhesive (not shown) is applied to the surface of the transfer sheet 7 on the side that attaches to the indicator component 1, and the transfer sheet 7 is joined to the indicator component 1 with an appropriate adhesive force. The material used for the transfer sheet 7 should be easy to peel off and attach to the indicator component 1; for example, polyethylene, polypropylene, or another flexible film or the like may be used, and SPV film J-300 manufactured by Nitto Denko, for example, may be used. Through the use of this type of transfer sheet 7, the indicator component 1 is held with the appropriate adhesion when the indicator component 1 is peeled from the substrate 4. Also, when a plurality of indicator components I is transferred, for example, by a single transfer sheet 7, the layout of the plurality of indicator components 1 relative to each other is maintained unchanged after the indicator components 1 are peeled off. A transparent film-shaped material may also be used as the material for the transfer sheet 7 to enable the indicator component 1 to be seen through the transfer sheet 7, or a gas-impermeable material may be used to prevent the adhesive on the transfer sheet 7 from drying.

After the transfer sheet 7 is affixed to the indicator component 1 and to the substrate 4, the transfer sheet 7, the indicator component 1, and the substrate 4 are joined together by roller tensioning in step S15. In step S16, the substrate 4 is peeled from the indicator component 1, and the indicator component 1 is transferred to the transfer sheet 7, as depicted in line (B) of FIG. 9. It is preferred that the bonding force between the substrate 4 and the indicator component 1 at this time be set to be weaker than the force with which the indicator component 1 is joined to the transfer sheet 7. Setting the bonding force in this manner allows the indicator component 1 to be transferred from the substrate 4 to the transfer sheet 7 as the transfer sheet 7 is peeled off. Besides peeling the indicator component 1 from the substrate 4, the transfer sheet 7 also fulfills the role of protecting the decorative faces 21 and 31 of the indicator component 1.

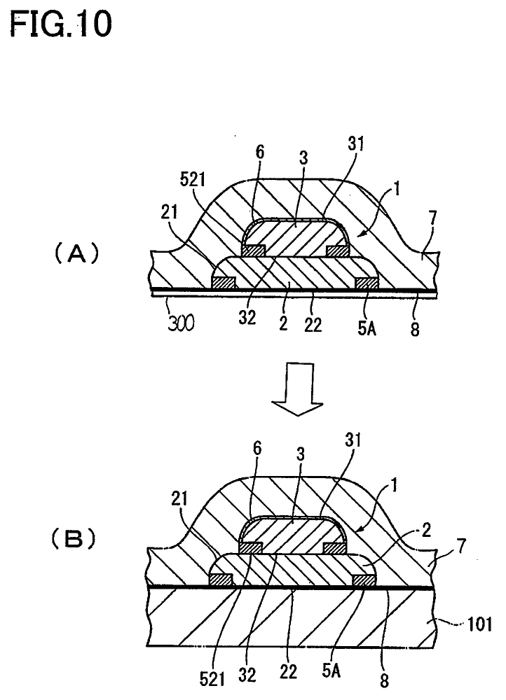

As seen in line (A) of FIG. 10, in the adhesive application step, an adhesive 8 as a joining instrument is applied to the affixed face 22 of the first electroformed part 2, the external surface of the remaining portion 5A, and the portions of the transfer sheet 7 outside the first electroformed part 2, and an adhesive layer is formed in step S17. In this case, a water-based pressure-sensitive adhesive (in which F-1040B acrylic elastomer resin manufactured by Tesk Co., an antifoaming agent, deionized water, methanol, and polyvinyl methyl ether (a thickening agent), for example, are admixed in prescribed ratios), for example, may be used as the adhesive 8. The adhesive should be applied by a screen printing machine to form an adhesive layer with a thickness of approximately 10 μm.

When the indicator component 1 is not immediately affixed to the dial 101, a configuration may be adopted whereby a peeling sheet 300 is affixed to the face on which the adhesive 8 is applied to form a sealing sheet, and the indicator component 1 is stored with the sealing sheet. In this arrangement, the material for the peeling sheet 300 is preferably impermeable to gases and has good peeling properties in relation to the adhesive 8; for example, a resin film or paper whose surface has been treated with a fluororesin. SP-8E Ivory with a thickness of t=0.11, manufactured by Lintec (Inc.), for example, may be used. The adhesive 8 is protected by this peeling sheet 300, and adhesion of debris on the adhesive 8 or evaporation of the solvent or moisture from the adhesive 8 is prevented. The indicator component 1 will adhere to the peeling sheet 300 if the peeling capability of the peeling sheet 300 is weak, so an appropriate level of peeling performance is required.

Referring now to line (B) of FIG. 10, in the affixing step, the indicator components 1 are affixed in prescribed positions to the dial 101 in step S18. First, contaminants are removed from the dial 101 in advance by rinsing (ultrasonic cleaning, acid cleaning, or the like) or the like in order to improve adhesion between the dial 101 and the indicator components 1.

The indicator components 1 are then positioned on the dial 101. This positioning may be performed using a fixture to fix the dial 101 in place and a positioning electroformed part formed on the indicator component 1, for example. In short, the dial 101 is first fixed in advance in an appropriate fixture. This fixture is provided with a positioning pin to determine the position of the indicator component 1 relative to the dial 101. On the side of the indicator component 1, a positioning electroformed part is formed on the periphery of the indicator component 1 at the same time as the indicator component 1 is formed, and this positioning electroformed part is transferred together with the indicator component 1 to the transfer sheet 7. The indicator component 1 is positioned relative to the dial 101 by engaging the positioning electroformed part with the positioning pin of the fixture in which the dial (substrate) 101 is fixed.

After the indicator component 1 is arranged in the prescribed position on the dial 101, the indicator component 1 is affixed to the dial 101 as depicted in line (B) of FIG. 10. The indicator component 1 is then pressed by a roller or the like from above the transfer sheet 7 to ensure adhesion thereof to the dial 101.

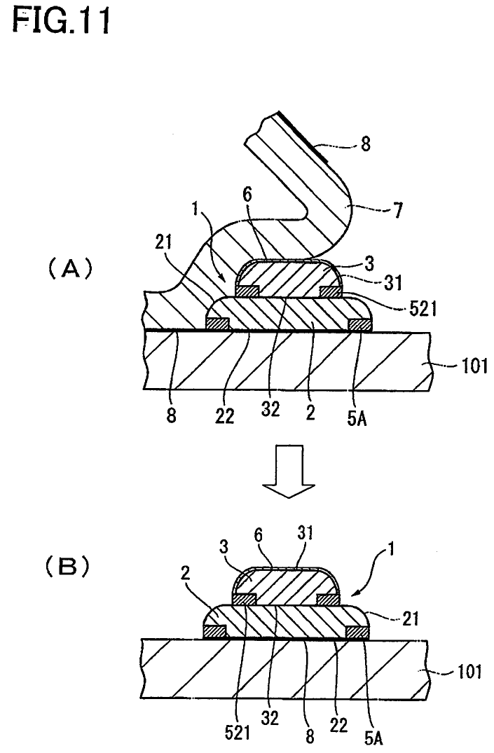

As shown in line (A) of FIG. 11, the transfer sheet 7 is then peeled off. The indicator component 1 is pressed and attached to the dial 101 at this time, so the indicator component 1 is joined to, and remains on, the dial 101 when the transfer sheet 7 is peeled off while the indicator component 1 is held down. The adhesive 8 in portions separate from the indicator component 1 adheres to the transfer sheet 7 and is peeled off together therewith. In short, it is preferred that the bonding force between the transfer sheet 7 and the adhesive 8 at this time be set to be greater than the force with which the adhesive 8 adheres to the dial 101. It is also preferred that the force with which the adhesive 8 adheres to the dial 101 be set to be greater than the force with which the indicator component 1 adheres to the transfer sheet 7. Under such conditions, the adhesive 8 in the portions outside the indicator component 1 is satisfactorily peeled off together with the transfer sheet 7. Even when it is difficult to satisfy such conditions, peeling off the transfer sheet 7 while holding down the indicator component 1 allows the indicator component 1 to be left behind on the dial 101, and the rest of the adhesive 8 can easily be peeled off together with the transfer sheet 7.

By such a step as described above, the indicator component 1 is affixed in the prescribed position on the dial 101, as depicted in line (B) of FIG. 11.

The following such effects are obtained by this type of embodiment.

(1) The second electroformed part 3 is further formed on the decorative face 21 of the first electroformed part 2, so the thickness of the indicator component 1 can be further increased, and the indicator component 1 can be endowed with a more pronounced three-dimensional appearance. The indicator component 1 can thereby be made in a greater variety of designs, whereby the dial 101 and the timepiece 100 can be made in an even greater variety of designs.

Also, the second electroformed part 3 is formed on the decorative face 21 of the first electroformed part 2 at this time, so the surface area of the decorative face 31 of the second electroformed part 3 is smaller than the surface area of the decorative face 21 of the first electroformed part 2, and the decorative face 21 of the first electroformed part 2 is exposed from the periphery of the decorative face 31 of the second electroformed part 3. The three-dimensional look of the indicator component 1 can therefore be further emphasized.

(2) The plating layer 6 is formed on the decorative face 31 of the second electroformed part 3, thus, an appearance can be created that is different from that of the first electroformed part 2. Consequently, a more defined three-dimensional look can be obtained in the indicator component 1. Various feels and colors can be added to the second electroformed part 3 by forming the plating layer 6, so the indicator component 1 can be made in an even greater variety of designs.

(3) By the manufacturing method whereby the first electroformed part 2 is formed on the substrate 4 and the second electroformed part 3 is formed by performing the second electroforming step with the decorative face 21 of the first electroformed part 2 as the substrate, the second electroformed part 3 can be formed directly on the decorative face 21 of the first electroformed part 2, and a two-stage indicator component 1 can be manufactured. Consequently, an indicator component 1 having a three-dimensional appearance can be manufactured by this method.

The second electroformed part 3 is also formed directly on the first electroformed part 2. Thus, there is no need to attach the second electroformed part 3 to the first electroformed part 2, the manufacturing process can be simplified, and the second electroformed part 3 can be reliably fixed to the first electroformed part 2. Unlike a case in which the second electroformed part 3 is attached to the first electroformed part 2, the forcing of the adhesive out into the external periphery of the second electroformed part 3 and other defects are eliminated, thus, an indicator component 1 having a good appearance can be manufactured with consistent quality.

Furthermore, the first electroformed part 2 and the second electroformed part 3 are formed on the same substrate 4 in the same manufacturing step, thus, the positioning of the second electroformed part 3 with respect to the first electroformed part 2 is made reliable, whereby an indicator component 1 can be manufactured with consistent quality.

(4) After the first electroforming part 51 is formed on the first resist 5 and the second electroforming part 53 is formed on the second resist 52, the entire face of the first resist 5 and second resist 52 is exposed to ultraviolet rays and the first resist 5 and second resist 52 on the substrate 4 are removed, so only the exposed portions of the first resist 5 and the second resist 52 are removed in advance. Consequently, the indicator component 1 can easily be peeled from the substrate 4 when the indicator component 1 is transferred from the substrate 4 to the transfer sheet 7. At this time, the first resist 5 and the second resist 52 are removed by the same ultraviolet exposure and development step as when the first electroforming part 51 and second electroforming part 53 are respectively formed on the first resist 5 and second resist 52. Therefore, after-baking such as is performed conventionally can be omitted, and the operational procedure can be simplified. There is also no need to use a specialized solvent to remove the first resist 5 and the second resist 52, and a conventional exposure device and developing solution can be used, allowing the materials needed for operation to be standardized and the cost of manufacturing the indicator component 1 to be reduced.

(5) In the conventional configuration, a decorative face protrudes outward from a first electroforming part, and a first resist is therefore incorporated into a first electroformed part and becomes difficult to peel from the first electroformed part. Due to the conventional structure, when the first electroformed part is peeled from the substrate and the first resist and is transferred to the transfer sheet, the first resist remains on the external periphery of the first electroformed part, which can lead to drawbacks whereby the appearance is adversely affected and the first electroformed part is deformed by the resistance of the first resist. In the present embodiment, the first resist 5 and the second resist 52 are removed in advance by ultraviolet exposure and development, so none of the first resist 5 and second resist 52 remains on the external periphery of the indicator component 1. The quality of the appearance of the indicator component 1 can therefore be enhanced. Also, since the first resist 5 and the second resist 52 on the substrate 4 can be removed, the substrate 4 can be reused and the cost of manufacturing the indicator component 1 can also be reduced.

(6) The remaining portions 5A and 521 respectively remain on the external periphery of the affixed face 22 of the first electroformed part 2 and the fixed face 32 of the second electroformed part 3. Thus, the indicator component 1 is fixed and retained on the substrate 4 even after the first resist 5 and the second resist 52 are removed. The handling properties of the indicator component 1 can therefore be enhanced.

The indicator component 1 is also firmly retained on the substrate 4, so the indicator component 1 can be accurately positioned when the indicator component 1 is transferred from the substrate 4 by the transfer sheet 7, and even when a plurality of indicator components 1 is manufactured, unevenness in the relative positioning thereof can be reliably prevented and the indicator components 1 can be accurately transferred to the transfer sheet 7. Even when a plurality of indicator components 1 is simultaneously manufactured and transferred to the dial 101, for example, positioning can be performed with good precision without creating nonuniformities in the relative positioning of the indicator components 1.

Since the first resist 5 remains on the external periphery of the affixed face 22 to constitute the remaining portion 5A, voids can be prevented from forming in the portion corresponding to the remaining portion 5A. It is therefore possible to prevent an excessive quantity of adhesive 8 from being supplied to the portion corresponding to the remaining portion 5A, and the adhesive 8 can be satisfactorily prevented from being forced out when the indicator component 1 is affixed to the dial 101. A consistent quality in appearance is also obtained as a result of these effects. Since an excessive amount of adhesive 8 is not supplied to the portion corresponding to the remaining portion 5A, the adhesive 8 in the portion corresponding to the remaining portion 5A can be prevented from spreading and becoming viscous when the indicator component 1 is transferred from the transfer sheet 7 to the dial 101. Defects such as those in which the adhesive 8 adheres to the dial 101 on the periphery of the indicator component 1 or to the decorative faces 21 and 31 of the indicator component 1 can thereby be eliminated, and the process yield in manufacturing of the indicator component 1 can be enhanced.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

### Alternate Embodiments

Alternate embodiments will now be explained. In view of the similarity between the first and alternate embodiments, the parts of the alternate embodiments that are identical to the parts of the first embodiment will be given the same reference numerals as the parts of the first embodiment. Moreover, the descriptions of the parts of the alternate embodiments that are identical to the parts of the first embodiment may be omitted for the sake of brevity.

A second preferred embodiment of the present invention will be described next. The second embodiment differs from the first embodiment with regard to the structure of the decorative part.

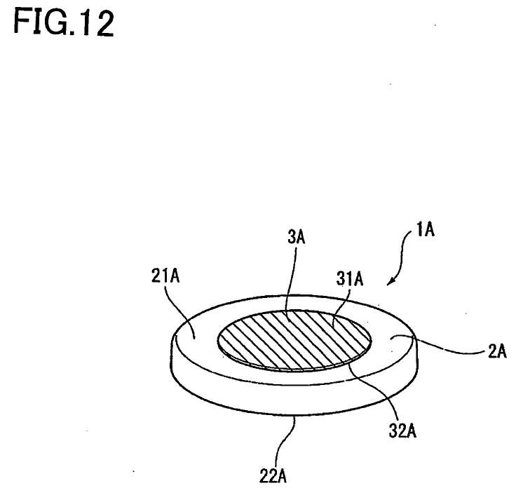

A perspective view is shown in FIG. 12 of an indicator component 1A as the decorative component according to the second embodiment of the present invention. As depicted in FIG. 12, the indicator component IA is provided with an electroformed part 2A affixed to the dial 101, and an electrodeposition coated part 3A as the surface-treated part (decorative part) formed on a decorative face 21 A of the electroformed part 2A.

The electroformed part 2A is preferably formed in the same shape as the first electroformed part 2 of the first embodiment. The electrodeposition coated part 3A is formed by electrodeposition coating on the electroformed part 2A and is provided with a fixed face 32A that is fixed to the decorative face 21A of the electroformed part 2A, and with a decorative face 31A that is separate from the fixed face 32A and whose surface can be visually identified from the outside. The electrodeposition coated part 3A is composed of a suitable material used for electrodeposition coating, and a coating material composed of acrylic resin, a fluororesin, or another material, for example, may be used therein (Elecoat (manufactured by Shimizu Co., Ltd), for example).

This type of indicator component 1A is manufactured by the following process.

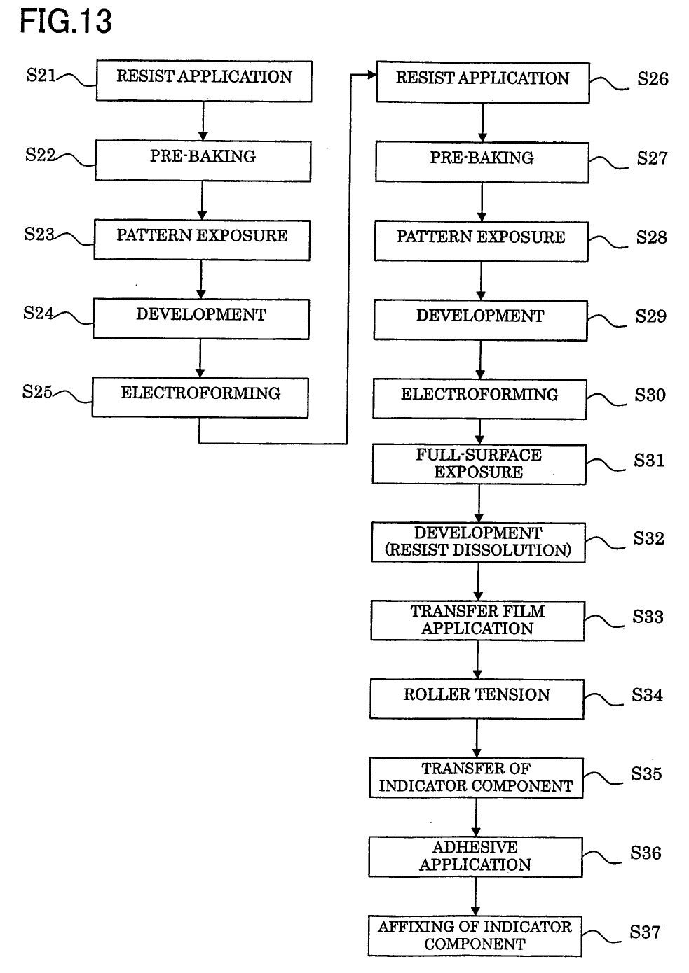

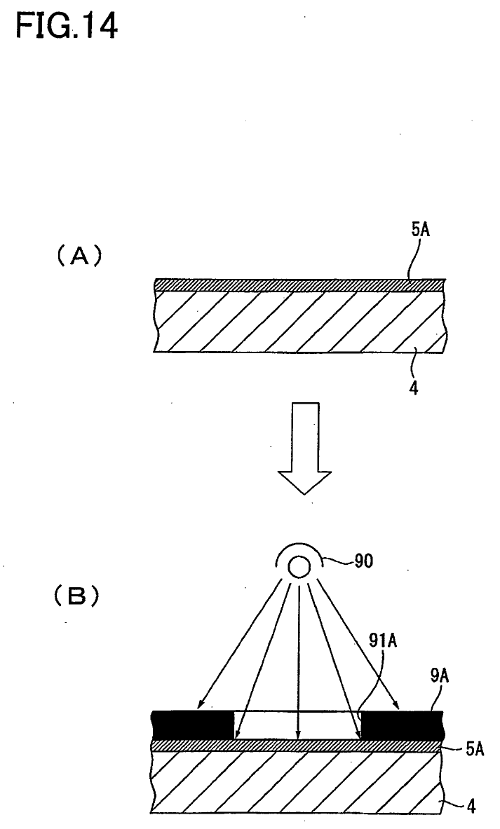

A flowchart of the manufacturing method of the indicator component 1A is shown in FIG. 13. The manufacturing steps leading to the completion of the indicator component IA are also shown in FIGS. 14 through 21. As shown in FIG. 13, the method for manufacturing the indicator component 1A has an electroformed part resist formation step (steps S21 through S24) to form an electroformed part resist used for the electroformed part 2A on the substrate, an electroforming step (step S25) to form the electroformed part 2A by using the electroformed part resist, a surface-treated resist formation step (steps S26 through S29, decorative part resist formation step) to form a surface-treated resist on the decorative face 21A of the electroformed part 2A as the decorative part resist used for the electrodeposition coated part 3A, an electrodeposition step (step S30, surface treatment step) to form the electrodeposition coated part 3A by using the surface-treated resist, and a resist removal step (steps S31 through S32) to remove the electrodeposition resist and the surface-treated resist on the substrate. The resist removal step is followed by a transfer step (steps S33 through S35), an adhesive application step (step S36), and an affixing step (step S37) in the same manner as in the first embodiment.

As shown in line (A) of FIG. 14, in the electroformed part resist formation step, the electroformed part resist 5A is first formed from a resist agent on the substrate 4 in step S21. In this arrangement, the same materials as in the first embodiment are preferably used for the substrate 4 and the resist agent.

In step S22, the electroformed part resist 5A is pre-baked by heat-treating the electroformed part resist 5A for each substrate 4. Pre-baking is performed by heating and drying the assembly at 90° C.±5° C. for 45 minutes. By this pre-baking step, the electroformed part resist 5A is stabilized, the adhesion thereof with the substrate 4 is improved, and peeling of the electroformed part resist 5A from the substrate 4 is prevented.

Next, in step S23, as shown in line (B) of FIG. 14, the electroformed part resist 5A is covered with a mask 9A and is exposed to ultraviolet rays. A transparent pattern 91A having substantially the same shape as that of the affixed face 22A of the electroformed part 2A is formed on the mask 9A, and pattern exposure whereby only the portion corresponding to the pattern 91 A is irradiated with ultraviolet rays is performed by exposing the electroformed part resist 5A to ultraviolet rays from a light source 90 through the mask 9A. By this pattern exposure, the shape of the pattern 91A is transferred to the portion of the electroformed part resist 5A irradiated with the ultraviolet rays, and the corresponding portion is degraded.

When the electroformed part 2A is formed on the substrate 4 in this arrangement, the electroformed part 2A protrudes from the electroformed part resist 5A in overlaid fashion, so the actual dimensions thereof are larger than the shape of the pattern 91A. Consequently, the shape of the pattern 91A is set after first taking into account this dimensional difference.

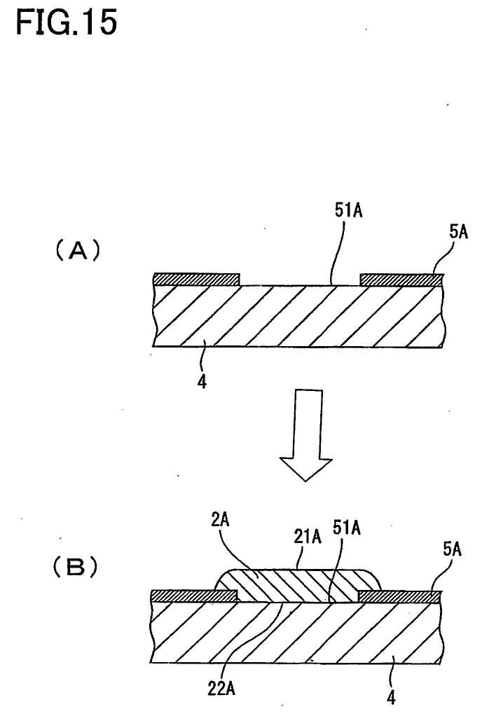

In step S24, the exposed substrate 4 and electroformed part resist 5A are developed and rinsed by a common alkali development, solvent method, or other method. As shown in line (A) of FIG. 15, the portion of the electroformed part resist 5A corresponding to the pattern 91A on the substrate 4 is then removed, and an electroforming part 51A is formed in the shape of the pattern 91A. The substrate 4 is exposed in the area inside this electroforming part 51A.

As shown in line (B) of FIG. 15, in the electroforming step, the electroformed part 2A is formed in step S25 by electroforming, as depicted in FIG. 15(B). Electroforming is performed under common electroforming conditions in the same or similar manner as in the first embodiment, and in this electroforming step, the electroforming solution is introduced into the area inside the electroforming part 51A on the substrate 4, the electroforming solution is forced out over the face of the electroformed part resist 5A on the external periphery of the electroforming part 51A, and the material is overlaid. In this electroforming step, an affixed face 22A is formed from the portion attached to the substrate 4, and a decorative face 21A is formed from the portion overlaid on the face on the opposite side from the substrate 4.

The after-baking to enhance the adhesion of the electroformed part resist 5A to the substrate 4 is not performed after the electroformed part resist 5A is developed and before the electroforming step is performed, in the same manner as in the first embodiment.

As shown in line (A) of FIG. 16, in the surface-treated resist formation step, a surface-treated resist 52A is formed on the decorative face 21A by the same method as is the electroformed part resist 5A in steps S26 and S27. In step S28, the surface-treated resist 52A and electroformed part resist 5A are then covered with a mask (not shown) in which a pattern is formed having substantially the same shape as the electrodeposition coated part 3A, and ultraviolet exposure (pattern exposure) is performed. The substrate 4 is developed in step S29, whereupon the portion of the surface-treated resist 52A in the pattern irradiated with ultraviolet rays is removed and an electrodeposition coating formation part 53A is formed such as depicted in line (B) of FIG. 16. The decorative face 21A of the electroformed part 2A is exposed in the area inside this electrodeposition coating formation part 53A.

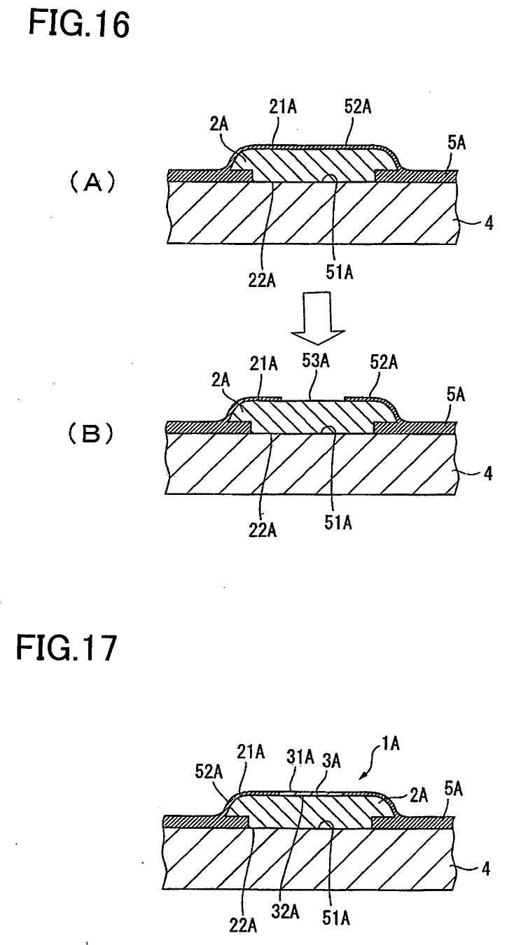

As shown in FIG. 17, in the electroforming step, the electrodeposition coated part 3A is formed by applying an electrodeposition coating in step S30. The electroformed part 2A and the electrodeposition coated part 3A must be affixed to each other at this time, so only activation treatment is performed, and such passivation treatment as was performed in the electroforming step becomes unnecessary.

In this electroforming step, the substrate 4 on which the electroformed part 2A is formed is immersed in an electrodeposition coating tank containing an electrodeposition solution, and the electrodeposition coated part 3A is formed in the area inside the electrodeposition coating formation part 53A on the decorative face 21A by applying an electric current. The temperature condition of the electrodeposition solution is preferably controlled to be 24±1° C. The applied current is proportional to the surface area of electrodeposition treatment, and if the substrate 4 were to have a surface area of 180 mm×260 mm, for example, electrodeposition should be performed for two minutes at a current of 2 A (amperes). The electrodeposition coated part 3A is formed with a thickness of approximately 10 μm and becomes nonconductive, so the electrodeposition coated part 3A is not formed with a thickness greater than 10 μm. The substrate 4 is then taken out of the electrodeposition coating tank and is rinsed with purified water. It is preferred that the substrate 4 not be subjected to any physical impact at this time. The substrate 4 is then placed in a dryer and dried for 20 to 30 minutes at 70° C., and the moisture in the electrodeposition coated part 3A is removed. The material for the electrodeposition coated part 3A may, for example, be the aforementioned material into which a pigment of a prescribed color has been admixed. Specifically, when, for example, the electrodeposition step is performed using only Elecoat UC-2000 (manufactured by Shimizu Co.) as the principal material, an electrodeposition coated part 3A composed of a semitransparent acrylic resin coat can be formed. If this principal material is colored by adding 10 to 25 wt % of a pigment, an electrodeposition coated part 3A of any color or tone can be formed. The color of the decorative face 21A of the electroformed part 2A is also mixed in because of the semitransparent quality of the electrodeposition coated part 3A, so an even greater variety of appearances is made possible by applying color by plating or the like to the decorative face 21A of the electroformed part 2A. Specifically, a pink-colored electrodeposition coated part 3A may be formed on an electroformed part 2A formed from nickel, for example, the electroformed part 2A may be plated with silver to form a pink-colored electrodeposition coated part 3A, or the like. When the electrodeposition coated part 3A is formed in a plurality of colors, a number of electrodeposition coating tanks corresponding to the number of colors used is preferably prepared in advance to prevent mixing of colors. In this case, the electrodeposition coating tanks are preferably made as compact as possible, and the same rectifiers and the like are preferably used for each.

The electrodeposition coated part 3A formed by this type of electrodeposition step is formed no thicker than the surface-treated resist 52A, and the electrodeposition coated part 3A is consequently formed so that it does not protrude from the external periphery of the electrodeposition coating formation part 53A. The fixed face 32A is thereby formed from the portion attached to the electroformed part 2A, and the decorative face 31A is thereby formed from the portion formed on the opposite face of the fixed face 32A.

After-baking is not performed after the surface-treated resist 52A is developed and before the electrodeposition step is performed.

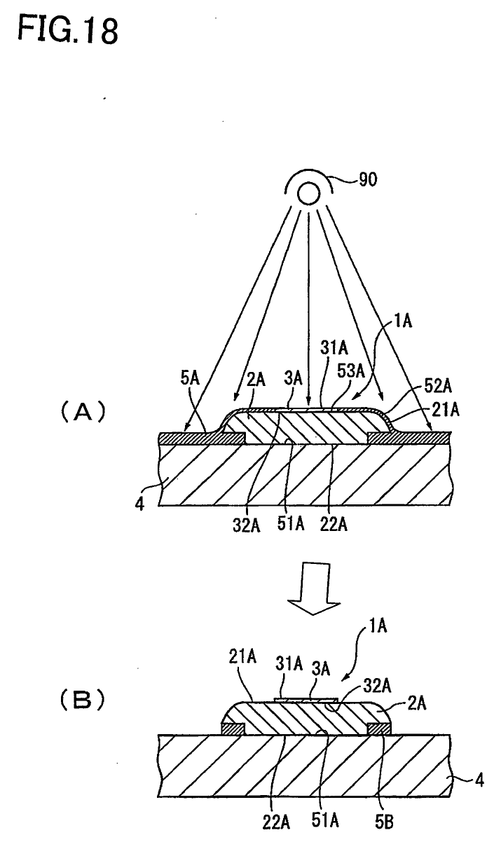

The resist removal step has an exposure step to irradiate the electroformed part resist 5A and surface-treated resist 52A with ultraviolet rays, and a development step to remove by image development the portion of the electroformed part resist 5A and surface-treated resist 52A exposed in the exposure step. First, the entire face of the electroformed part resist 5A and surface-treated resist 52A on the substrate 4 is exposed to ultraviolet rays from a light source 90 in step S31, as depicted in line (A) of FIG. 18 (exposure step). The portions of the electroformed part resist 5A and surface-treated resist 52A that are exposed to the outside are thereby irradiated with ultraviolet rays from the light source 90, and the resist agent in the corresponding portions is degraded. At this time, the electrodeposition coated part 3A is hardened by the exposure step.

The substrate 4 is then developed in step S32, whereupon the electroformed part resist 5A and surface-treated resist 52A thus irradiated are dissolved and removed as depicted in line (B) of FIG. 18, and the decorative face 21A of the electroformed part 2A and the substrate 4 on the periphery thereof are exposed (development step). In this arrangement, the development device, development conditions, and other factors used in the development step are the same as in the development operation of the electroformed part resist formation step.

The indicator component 1A is formed on the substrate 4 and manufactured according to the manufacturing process described above. Since alkali components adhere to the surface of the indicator component 1A after the development step, the process is completed after the component is washed with an acid.

In this arrangement, the decorative face 21A protrudes over the face of the electroformed part resist 5A while overlaid on the external periphery of the affixed face 22A of the electroformed part 2A, so a portion exists that is not exposed to ultraviolet rays due to being covered by the decorative face 21A. This portion of the electroformed part resist 5A is therefore not degraded, and the remaining portion 5B of the electroformed part resist 5 is left behind in this portion.

At this time, activation treatment and passivation treatment are performed between the affixed face 22A of the electroformed part 2A and the substrate 4, so these components are easily peeled apart. Since the remaining portion 5B that is not exposed on the external periphery of the affixed face 22A is left behind when the electroformed part resist 5A and the surface-treated resist 52A are removed, the indicator component 1A is fixed and retained on the substrate 4 by the bond between the remaining portion 5B and the electroformed part 2A.

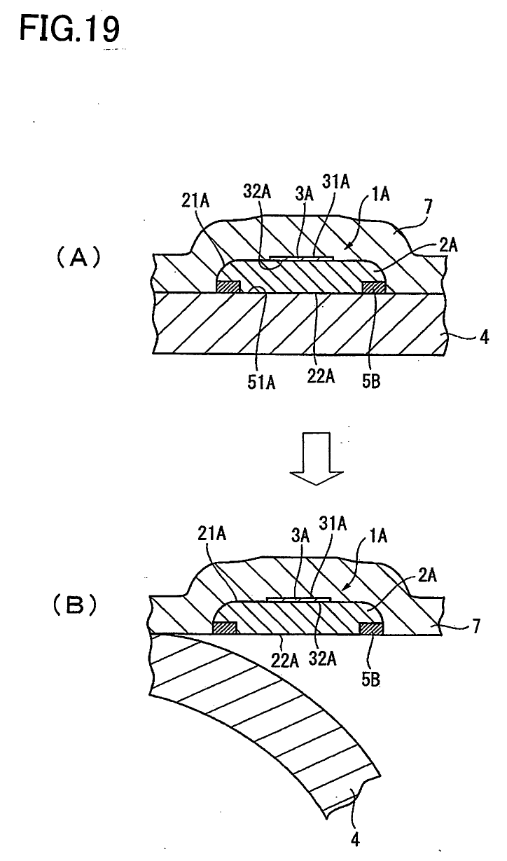

In the transfer step, a transfer sheet 7 is affixed to the indicator component 1A and the substrate 4 in step S33, as depicted in line (A) of FIG. 19. An adhesive (not shown) is applied to the surface of the transfer sheet 7 on the side that attaches to the indicator component 1A, and the transfer sheet 7 is joined to the indicator component 1A with an appropriate adhesive force. The same material as in the first embodiment may be used for the transfer sheet 7.

After the transfer sheet 7 is affixed to the indicator component 1A and to the substrate 4, the transfer sheet 7, the indicator component 1A, and the substrate 4 are joined together by roller tensioning in step S34. In step S35, as shown in line (B) of FIG. 19, the substrate 4 is peeled from the indicator component 1A, and the indicator component 1A is transferred to the transfer sheet 7.

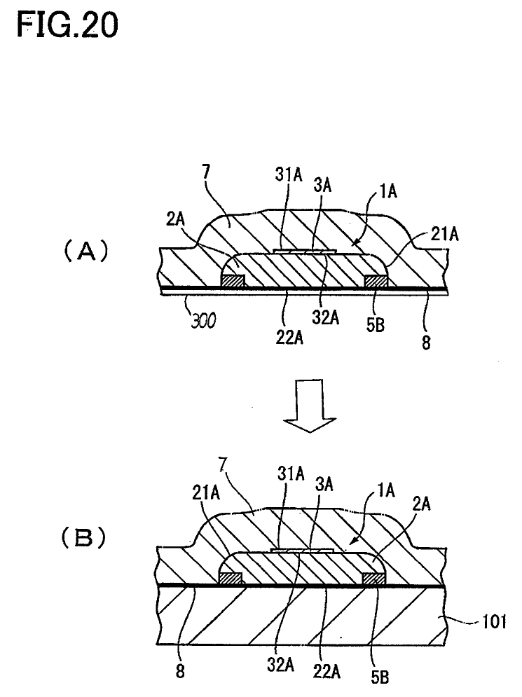

In the adhesive application step, an adhesive 8 is applied the affixed face 22A of the electroformed part 2A, the external surface of the remaining portion 5B, and the portions of the transfer sheet 7 outside the electroformed part 2A, and an adhesive layer is formed in step S36, as depicted in line (A) of FIG. 20.

When the indicator component 1A is not immediately affixed to the dial 101, a configuration may be adopted whereby a peeling sheet 300 is affixed to the face on which the adhesive 8 is applied to form a sealing sheet, and the indicator component 1A is stored with the sealing sheet. In this arrangement, the material for the peeling sheet 300 is preferably impermeable to gases and has good peeling properties in relation to the adhesive 8, for example, a resin film or paper whose surface has been treated with a fluororesin. Adhesion of debris by the adhesive 8 or evaporation of the solvent or moisture from the adhesive 8 is prevented by this peeling sheet 300.

In the affixing step, as shown in line (B) of FIG. 20, the indicator component 1A is bonded in a prescribed position on the dial 101 in step S37 in the same or similar manner as in the first embodiment.

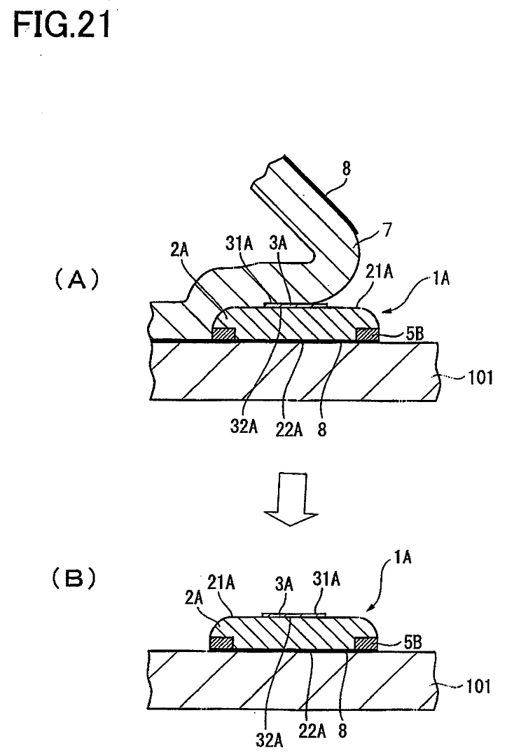

The transfer sheet 7 is then peeled off as depicted in line (A) of FIG. 21. The indicator component 1A is pressed and attached to the dial 101 at this time, so the indicator component 1A is joined to, and remains on, the dial 101 when the transfer sheet 7 is peeled off while the indicator component 1A is held down.

By such a step as described above, the indicator component 1A is affixed in the prescribed position on the dial 101, as depicted in FIG. 21(B).

Such effects as the following are obtained by this type of second embodiment.

(7) The electrodeposition coated part 3A is formed on a portion of the decorative face 21A of the electroformed part 2A, so the electrodeposition coated part 3A protrudes from the decorative face 21A by an amount commensurate with the thickness thereof, and the indicator component 1A can be endowed with a more pronounced three-dimensional appearance. Also, the electrodeposition coated part 3A is formed on a portion of the decorative face 21A of the electroformed part 2A, so the decorative face 21A of the electroformed part 2A is exposed from the periphery of the decorative face 31A of the electrodeposition coated part 3A. The three-dimensional look of the indicator component 1A can therefore be further emphasized, and the indicator component 1A can be configured in two colors, made up of the metallic color of the electroformed part 2A and the coating color of the electrodeposition coated part 3A. The indicator component 1A can thereby be made in a greater variety of designs, whereby the dial 101 and the timepiece 100 can be made in an even greater variety of designs.

(8) The electrodeposition coated part 3A is formed by electrodeposition coating, so green, blue, burgundy, and other metallic colors can be created, and the indicator component 1A can be endowed with a high-grade feel. Since a blue color can also be produced by an electrodeposition coating, various hues can be produced. Designs for the indicator component 1A can be even further diversified by this effect.

(9) With the manufacturing method in which the electrodeposition coated part 3A is produced by forming the electroformed part 2A on the substrate 4, forming the surface-treated resist 52A on the decorative face 21A of the electroformed part 2A, and performing the electrodeposition step only for the electrodeposition coating formation part 53A, the electrodeposition coated part 3A can be formed on a portion of the decorative face 21A of the electroformed part 2A. Consequently, an indicator component 1A having a two-stage, two-color structure can be manufactured by a continuous manufacturing process, and an indicator component 1A having a three-dimensional appearance can be manufactured with greater ease than when a seal-shaped electrodeposited image is attached to a portion of the surface of an electroformed product, for example. The electrodeposition coated part 3A can also be reliably fixed to the electroformed part 2A by this method, and forcing of the adhesive out into the external periphery of the electrodeposition coated part 3A and other defects are eliminated, allowing an indicator component 1A having a good appearance to be manufactured with consistent quality.

Furthermore, the electroformed part 2A and the electrodeposition coated part 3A are formed on the same substrate 4 in the same manufacturing step, so the positioning of the electrodeposition coated part 3A with respect to the electroformed part 2A is made reliable, whereby an indicator component 1A can be manufactured with consistent quality.

(10) After the electroforming part 51A is formed on the electroformed part resist 5A, and the electrodeposition coating formation part 53A is formed on the surface-treated resist 52A, the entire face of the electroformed part resist 5A and surface-treated resist 52A is exposed to ultraviolet rays, and the electroformed part resist 5A and surface-treated resist 52A on the substrate 4 are removed, so only the exposed portions of the electroformed part resist 5A and the surface-treated resist 52A are removed in advance. Consequently, although the structure is different, the same effects are obtained as those described in point (4) in the first embodiment.

(11) The electroformed part resist 5A and the surface-treated resist 52A are removed in advance by the exposure step and the development step, so none of the electroformed part resist 5A and surface-treated resist 52A remains in the external periphery of the indicator component 1A. Consequently, although the structure is different, the same effects are obtained as those described in point (5) in the first embodiment.

(12) The remaining portion 5B remains on the external periphery of the affixed face 22A of the electroformed part 2A, so although the structure is different, the same effects are obtained as those described in point (6) in the first embodiment.

The present invention is also not limited to the previously described embodiments, and also encompasses modifications, improvements, and the like that are within a range whereby the objects of the present invention can be achieved.

The configuration whereby a single decorative part is formed on the electroformed part is not limiting, and a configuration may be adopted whereby yet another decorative part is formed on the decorative face of the decorative part. By repeating this step a suitable number of times, a decorative part having three or more stages (a plurality of stages) can be formed on the electroformed part, for example. By adopting such a configuration, it becomes possible to create decorations in any number of colors on the electroformed part; a multicolored design can be obtained; the number of combinations of a plurality of hues, colors, textures, and the like increases, and diverse designs can be obtained.

The configuration whereby a single decorative part is formed on the electroformed part is not limiting, and the decorative component may be in the form of a plurality of decorative parts formed on an electroformed part, for example. In this case, a process may be performed whereby exposure and development are performed using a mask that has a transparent pattern in which the shapes of a plurality of decorative parts are formed in the decorative part resist formation step, and a decorative part resist is formed having the shape of a plurality of decorative parts. A plurality of decorative parts can thereby be simultaneously manufactured in the decoration step, and decorative components can be obtained that have consistent quality and accurate positioning relative to each other.

The planar shape of the electroformed part and the decorative part as viewed from the viewing direction is not limited to a circular shape, and this shape can be arbitrarily set according to the application. For example, the electroformed part and the decorative part may be shaped as a specified pattern. The cross-sectional shape of the electroformed part and the decorative part as viewed from the viewing direction is not limited to a planar shape, and may also be a curved surface. Furthermore, there is no need for the electroformed part and the decorative part to both be of the same shape or to be shaped similarly to each other, and each may be separately and independently fashioned in a suitable shape. For example, the electroformed part may be circular, and the decorative part may be in the shape of a specified pattern. In this case, a decorative part having a specified pattern can be formed on the basis of the electroformed part, so the three-dimensional look of the decorative component can be better produced and the decorative component can be formed using different-colored parts, whereby the designs can be further diversified. For example, when the decorative part is in the shape of a symbol or other mark, the symbol can be formed three-dimensionally because it has a different color tone or color appearance from the electroformed part. In short, the shape of the electroformed part and the decorative part may be formed as desired or needed, the electroformed part may have any shape that that can be obtained by electroforming, and the decorative part may have any shape that allows the prescribed electroforming, surface treatment, or other prescribed decoration to be performed.

The geometric position of the decorative part with respect to the electroformed part is also not necessarily the center of the electroformed part, and the decorative part may be arranged so that the center positions of the shapes are offset from each other to produce a three-dimensional look, for example. In short, the positional relationship of the electroformed part to the decorative part may be arbitrarily set according to the application and the like.

The electroformed part and the decorative part may be composed of the same material, or different materials may be used in each.

The resist removal step is not limited to a method for performing exposure and development to remove the excess portions, and may also be a method for dissolving the electroformed part resist and the decorative part resist by using a specialized solvent, for example. At this time, after-baking may be performed following the electroformed part resist formation step in order to increase the adhesion of the electroformed part resist to the substrate, and after-baking may also be performed following the decorative part resist formation step. However, when after-baking is performed, the electroformed part resist and the decorative part resist can sometimes penetrate into the electroformed part or the decorative part as a result of curing, and the peeling properties thereof with respect to these parts can suffer, so the electroformed part resist and the decorative part resist are preferably removed in advance by exposure and development.

The decorative component is not limited to protruding over the face of the electroformed part resist and being overlaid, and may be formed with a thickness that is equal to or less than that of the electroformed part resist. The electroformed part resist can be reliably removed by performing exposure and development, and a decorative component having a good appearance can be obtained in this case as well.

The exposure step and the development step are not limited to a method whereby the entire faces of the electroformed part resist and the decorative part resist are exposed on the substrate, and may involve any method whereby at least the periphery of the decorative component is exposed and developed. A decorative component having a good appearance can be manufactured in this case as well because the electroformed part resist and the decorative part resist in the periphery of the decorative component can be easily and reliably removed. As in the first embodiment, when a plurality of stages (two stages) is formed, such as when the electroformed part is composed of a first and second electroformed parts, at least the periphery of the first electroformed part and the decorative face of the first electroformed part are exposed to ultraviolet rays.

The separation step is not limited to a transfer step that uses a transfer sheet, and any other method may be employed whereby the decorative component can be separated from the substrate.

The decorative component is not limited to being manufactured one at a time by a single manufacturing process, and a plurality of decorative components may also be simultaneously manufactured by a single manufacturing process, for example. In this case, the substrate is fashioned to a size in which a plurality of decorative components can be formed, and an electroformed part resist is formed using a mask having a pattern in which the shapes of a plurality of electroformed parts are formed in advance. A plurality of electroformed parts is simultaneously formed by subsequently performing the electroforming step. The decorative part can also be formed in the same manner by forming a decorative part resist with a mask in which the shapes of a plurality of decorative parts are formed and performing the decoration step. With this type of manufacturing method, a plurality of decorative components can be manufactured using a single manufacturing process, so the decorative components can be manufactured with greater efficiency.

Decorative components are extremely difficult to position, particularly when a plurality of decorative components is arranged on a dial, for example. In view of this, by simultaneously manufacturing a plurality of decorative components in advance in an arrangement in which the components are affixed to a dial by a manufacturing process such as previously described, the relative positions of the plurality of decorative components can be reliably transferred by simultaneously transferring the components with a transfer sheet. At this time, the transfer sheet is useful because it prevents the decorative components from being positioned nonuniformly in relation to each other, and a plurality of decorative components can therefore be positioned at once when the components are affixed to the dial, and each decorative component can be accurately positioned.

The electroformed part resist and the decorative part resist may be composed of the same material or different materials.

In addition to flash plating with gold (Au), the surface treatment in the first embodiment or the surface-treated part in the second embodiment may involve the application of Rh plating, black Ni plating, Sn plating, black Cr plating, matte Ni plating, or any other surface treatment to impart a tint or finish variation to the product. The surface treatment is not limited to plating, and coloring may also be performed by spray coating, electrodeposition coating, or the like. Furthermore, the surface treatment is not limited to covering the decorative face with another material; for example, the surface may be roughened to a surface roughness of about 1.2 S to 6.3 S by sandpaper or honing, a mirror finish may be applied, or treatment may be performed to balance the surface condition of the decorative face.

The surface treatment in the first embodiment is not limited to being applied to the decorative face of the second electroformed part, and may also be applied to the decorative face of the first electroformed part. In short, the surface treatment may be applied to any one of either the first electroformed part or the second electroformed part. The surface treatment may also be applied to at least a portion of the decorative face of any one of either the first electroformed part or the second electroformed part, and the surface treatment may also be applied both to the first electroformed part and to the second electroformed part. If electrodeposition coating or another surface treatment is performed only on a portion of the decorative face of the second electroformed part, for example, a specified pattern or the like can be added on the decorative face of the second electroformed part, and even further diversification in the design of the decorative component can be obtained. The same surface treatment may also be applied to both the first and second electroformed parts, or separate surface treatments may be applied to each. In short, the surface treatment is applied to the decorative face of at least one of either the first electroformed part or the second electroformed part.

The decorative component can be used to decorate the dial of a wristwatch, a wall clock, a pocket watch, or any other timepiece. The decorative component is also not limited to being used on the dial of a timepiece, and can be used to decorate the windscreen, hands, case, movement components of a timepiece (main plate, oscillating weight, train wheel bridge, and the like), wristwatch band, or any other part of a timepiece.

The decorated component is not limited to a timepiece, and may also be a necklace, bracelet, or other accessory; a nameplate, calling card, mobile telephone, or other portable electronic device or the like; or any other decorated product.

The preferred configuration, method, and the like for implementing the present invention are disclosed in the above description, but the present invention is not limited thereby. Specifically, the present invention is particularly depicted and described mainly with regard to specific embodiments, but one skilled in the art may add various modifications of shapes, materials, quantities, and other structural details to the embodiments described above without departing from the technological intent or the range of objects of the present invention.

Consequently, descriptions in the above disclosure that limit shapes, materials, or the like are given by way of example in order to aid in understanding the present invention, and do not limit the present invention, so descriptions under the name of members that are outside some or all of the limits on shapes, materials, and the like are also included in the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least±5% of the modified term if this deviation would not negate the meaning of the word it modifies.

This application claims priority to Japanese Patent Applications No. 2003-417723, No. 2003-417725, No. 2003-417728 and No. 2004-328160. The entire disclosure of Japanese Patent Applications No. 2003-417723, No. 2003-417725, No. 2003-417728 and No. 2004-328160 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A decorative component comprising:
an electroformed part being formed by electroforming, said electroformed part having a decorative face; and
a decorative part being formed directly on said decorative face.

2. The decorative component according to claim 1, wherein
said decorative part is formed by direct electroforming on said decorative face.

3. The decorative component according to claim 2, wherein
said decorative part partially covers said decorative face.

4. The decorative component according to claim 2, further comprising,
a resist layer located on a peripheral part of a fixed face of said decorative part that is directly fixed onto said decorative face.

5. The decorative component according to claim 1, further comprising,
a surface-treated layer formed on at least one of said electroformed part and said decorative part, said surface-treated layer having a surface on which a surface treatment is performed.

6. The decorative component according to claim 5, wherein
said surface-treated layer is formed by plating.

7. The decorative component according to claim 5, further comprising,
an adhesive layer, wherein
said electroformed part further includes an affixed face on which said adhesive layer is located.

8. The decorative component according to claim 7, further comprising
a resist layer located on a peripheral part of said affixed face.

9. The decorative component according to claim 1, wherein
said first decorative part is made of a surface-treated part on a portion of said decorative face.

10. The decorative component according to claim 9, wherein
said surface-treated part is formed by plating or electrodeposition coating.

11. A timepiece comprising:
a time indicating part including a dial;
an electroformed part being formed on said dial by electroforming, said electroformed part having a decorative face; and
a decorative part being formed directly on said decorative face.

12. A method for manufacturing a decorative component comprising:
forming a first resist layer on a substrate, said first resist layer being an electroformed part having a predetermined pattern;
electroforming said electroformed part on said substrate;
forming a second resist layer on said electroformed part, said second resist layer being a decorative part having a predetermined pattern; and
decorating said decorative part on said electroformed part.

13. The method for manufacturing a decorative component according to claim 12, wherein
decorating said decorative part includes electroforming a second time to form a second electroformed part on said decorative part.

14. The method for manufacturing a decorative component according to claim 12, wherein
decorating said decoration part includes performing a surface treatment to form a surface-treated part on a portion of said decorative face.

15. The method for manufacturing a decorative component according to claim 14, wherein
performing said surface treatment includes performing electrodeposition to apply plating or a electrodeposition coating on said electroformed part.

16. The method for manufacturing a decorative component according to claim 12, further comprising,
exposing at least a periphery of said decorative part to ultraviolet rays after decorating said decoration part, and
removing by image development a portion of said electroformed part and/or said decorative part exposed, wherein
said first and second resist layers are an ultraviolet-degrading type that is degraded by irradiation with ultraviolet rays.

17. The method for manufacturing a decorative component according to claim 12, wherein electroforming said electroformed part includes forming said electroformed part in a protruding fashion over said first resist layer.

18. A sealing sheet comprising:
a decorative component having,
an electroformed part being formed by electroforming, said electroformed part having a decorative face, and
a decorative part being formed directly on said decorative face;
an adhesive layer being located on said electroformed part, said adhesive layer being configured to affix said decorative component to a decoration component;
a peeling sheet being detachably attached to said adhesive layer; and
a transfer sheet being attached to said decorative component.

19. A method for making a timepiece comprising:
providing a time indicating part including a dial; and
forming onto said dial a decorative component having an electroformed part formed by electroforming, said electroformed part having a decorative face, and a decorative part being formed directly on said decorative face.

20. A method for making a timepiece comprising:
providing a time indicating part including a dial;
providing a sealing sheet having,
a decorative component having,
an electroformed part being formed by electroforming, said
electroformed part having a decorative face, and
a decorative part being formed directly on said decorative face,
an adhesive layer being located on said electroformed part, said
adhesive layer for affixing said decorative component to a decoration component,
a peeling sheet being detachably attached to said adhesive layer, and
a transfer sheet being attached to the opposite face of the decorative component from the side on which the peeling sheet is provided;
removing said peeling sheet from said adhesive layer;
attaching said decorative component onto said dial by said adhesive layer; and
removing said transfer sheet from said decorative component.
